(19) United States
(12) Patent Application Publication
(10) Pub. No.: US 2009/0035110 A1
(43) Pub. Date: Feb. 5, 2009

(54) Backfilling apparatus with dual telescopically positionable material dispensers

(76) Inventor: James D. Woods, JR., Vista, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 12/221,372

(22) Filed: Aug. 1, 2008

Related U.S. Application Data
(60) Provisional application No. 60/963,256, filed on Aug. 3, 2007.

(51) Int. Cl. E02F 7/00; E02F 5/22; B65G 41/00; B65G 21/14

(52) U.S. Cl. 414/489; 405/179; 414/523; 198/311; 198/313

(57) ABSTRACT

A vehicle for transport and placement of fill material in trenches and for backfilling. The vehicle features a tiltable hopper connected to a central portion of a chassis which may be tilted to adjust the vehicle's center of gravity. Two conveyors deposit two independent volumes of fill material on or adjacent to a target through the positioning of one conveyor a distance from the hopper further than the other. The speed of the conveyors or the volume of fill material placed thereon may be varied to vary each respective discharged volume of material from each conveyor. The conveyors and hopper may be engaged to the base of the vehicle on a chassis that is rotatable on the base and fluid dispensers may be positioned over each conveyor to dampen the fill material.

### BACKGROUND OF THE INVENTION

1. Field of the Invention

This application claims the benefit of U.S. Provisional Application Ser. No. 60/963,256 filed Aug. 3, 2007, and which is incorporated herein in its entirety by reference. The present invention relates to heavy equipment used in construction. More particularly, it relates to large earth moving machinery conventionally employed in trenching. More particularly it relates to a device to enhance and the subsequent burial of structures in previously formed earthen trenches such as pipelines and the replacement of soil and other material employed to properly bury the trench-mounted structures and/or to backfill structures such as retaining walls during heavy construction.

2. Prior Art

Construction projects involving the removal and replacement of soil have been an ongoing process for millennia. Inevitably, such construction projects, large and small, require the excavation of trenches and burial of pipelines and other structures therein. The burying of structures in such trenches results in the need to subsequently replace the soil or other material in such trenches, and behind walls, to cover over pipelines and cables and such other utilities or structures designated to be subterranean.

The placement of sand, stone or gravel in a tight area such as a pipe trench in an accurate fashion can be one of the most time-consuming and costly tasks at a construction job site. A frequent requirement during burying of structures such as a pipeline is the requirement of placement of fill material equally on both sides of the trench-positioned pipeline, simultaneously. Material for such a fill must generally be placed to exacting specifications especially when covering pipelines and other underground utilities intended to become infrastructure and to last a long period of time.

Additionally, there frequently are concerns about disturbing the surrounding environment by such use of heavy machinery to place aggregate materials. Should the aggregate or soil of other burying material be misplaced by the machine operator, for instance in a position to enter a protected wetlands, it can have costly consequences. Consequently, careful placement of fill materials is a constant and costly requirement in modern construction. Further, since many times pipes, tanks or other under-slab materials can also be damaged using conventional backfilling techniques, even filling trenches in the conventional fashion can become fraught with peril to the intendant operator of conventional equipment.

Conventional operations position the gravel, aggregate, soil, or other material to be used for the fill over subterranean structures in trenches and behind walls by trucking it in and placing it in mounds on the ground for future use. During the burying process, in a second step, the fill material must be subsequently loaded into a hopper and/or a bucket or other storage means of the fill depositing machine. The machine is then employed to deposit the fill material where it is needed. Depending on the size and access available to the job site, this can take several men and machines many hours to complete.

In many large, wide and deep excavations, conventionally available equipment cannot reach the pipeline centerline to evenly distribute the fill on both sides of the pipeline. Consequently, the fill material may take two machines at once, or use manual labor to evenly distribute the fill material around the buried pipeline. Not only is this an outdated process, but it is such a time consuming labor intensive process that it is inefficient and costly to project owners and contractors.

Further, on large projects such as water pipelines intended to transport water long distances, many tons of fill material can be lost just during the transferring process from ground to the machine. This problem is increased with the risk of accidental placement of material improperly in protected areas or in a fashion that actually damages the pipeline itself by impact of the fill material.

A number of prior devices have attempted and achieved a solution to some degree in this complex area. U.S. Pat. No. 6,763,925 (Woods) provided a substantial leap forward in the required burying of structures in trenches as it discloses a self propelled backfilling apparatus which employs a single elongated conveyor belt to accurately dispense aggregate and such burial material into trenches and behind walls and the like. The stream of aggregate fill may be bifurcated at the distal end of the single conveyor if desired by cutting the single stream in half into two streams of material of half volume. The dispensing hopper of Woods will self level in its engagement to the chassis. While a great leap forward, the Woods device provides only a single divisible stream of burial material thereby cutting the volume of each stream in half during placement which can be slow on jobs where the burial requires miles of trench to be filled.

As such, there exists a need for an improved backfilling apparatus which will provide for the easy transport and placement of fill material used in construction projects in an accurate placement and consistent volume. Such a device should provide for the easy transportation of the material itself without excessive loss during transport. Additionally, such a device should provide the user increased utility in the placement of fill or particulate by allowing for multiple independently regulatable streams of fill material to be concurrently deposited, very accurately, in trench burial projects. Such a device would thus be much faster than the devices employed currently in the art and by employing a plurality of independently adjustable particulate or soil streams which may be adjusted not only for the speed of deposit of the material in each stream independently, but also the exact placement in the trench or on the ground of each stream is also independently adjustable.

Additionally, such a trench filling device should maintain its own center of gravity during transport, as well as during the fill depositing process, to thereby provide a means to prevent tipping of the heavy machine. Further, in a particularly preferred mode, such a device should also allow for a 360-degree rotation of the frame or chassis from which the conveyors extend, to thereby provide infinite adjustability as to the angle at which the double conveyors extend toward the fill position. Still further, the telescoping conveyors should be formed of a plurality of engaged telescopic components to insure a compact conveyor structure in their non-extended form, to thereby allow for maximum maneuverability of the device when moving around in frequently crowded construction sites.

### SUMMARY OF THE INVENTION

The disclosed device is capable of use as a complete backfilling unit with material reservoir or hopper for storage and transport of fill material on a tracked platform. Engaged to the apparatus is a plurality of individually speed-controllable conveyors and a plurality of fill material regulators for dispensing fill to the conveyors which singularly or in combination provide means to control the amount of fill material dispensed by the distal end of each conveyor. The two conveyors are engaged to the backfilling apparatus having means to tilt each individual conveyor at any angle between a maximum inclining angle and minimum declining angle. Each conveyor is also telescopic using translating segments between the attachment end to the backfilling apparatus and the distal end of the conveyor thereby providing means to adjust the distance of the distal ends from the conveyor unit and thereby adjust the placement of the individual streams of fill material discharged from each conveyor.

The backfilling unit can be manufactured as a complete unit originally, or, the two conveyors can be engaged in a retrofit to a hopper type vehicle for mounting and use in combination with existing conveyer systems used in the placement of fill material. The device in the current preferred mode is provided in a complete unit featuring a hopper for holding earthen fill material such as gravel, sand, soil, or similar conventionally used materials. The hopper is mounted upon a chassis or support structure of a vehicle that is moveable by conventional wheel and axle or tread mounted systems of propulsion. The dual telescopic conveyer system is also mounted upon the chassis in a position to receive material from the two material dispensing regulators or such as the depicted slide gates, communicating with the hopper at a first end of each conveyer. The two conveyors receive the regulated amount of earthen material from the hopper and communicate it to respective distal ends for extremely accurate placement in trenches, behind walls, over pipelines, and in similar conventional positions in which fill is required. The dual telescopic conveyors also have means to change their angle relevant to engagement to the vehicle from a maximum inclining angle to a minimum declining angle thereby allowing communication of earthen material from the hopper to positions higher or lower than the device itself.

In a preferred mode of the disclosed device, each conveyor has means to vary the speed of the belts on that individual conveyor, and hence the speed of dispensing of the fill material deposited on the respective belts. The variance between the speed of the two belts is essentially infinite since each can be adjusted to its own speed relative to the other at all times. Also preferred is a means to tilt the hopper during transport and/or use while depositing fill onto the conveyors to self correct its center of gravity. Additionally the extension length and tilting of the two conveyors can also be employed for the same purpose in combination with the hopper or individually.

In the preferred mode of the device, the means to regulate fill material volume is in the form of a slide gate. The slide gates are engaged between each conveyor and the flow of earthen material from the hopper. Each regulator shown-in the current preferred device as a slide gate can regulate the flow of material independently to its respective receiving conveyor which constantly receives the fill material transported by the conveyor from the hopper for dispatch from its respective distal end.

As each conveyor is telescoped its distal end toward or away from the hopper, the deposit of fill material from the distal end of each conveyor is accurately positionable. Consequently, the translation of each conveyor provides a means to very accurately position the respective distal end at a desired position where fill is to be placed. Since both distal ends of each respective conveyor are positionable to an infinite number of positions relative to each other, the two separate discharge streams of fill material can be infinitely adjusted for proper placement in the trench. By varying, either or both, the speed of each conveyor, and the amount of material communicated to each conveyor through each regulating slide gate from the hopper, the amount of material placed in each separate material stream from each respective distal end of a conveyor is infinitely variable respective to the other.

In an especially preferred mode of the device, means to deposit water such onto a feeder belt providing fill material from the regulator to each conveyor is provided such that the fill material communicated to the conveyor belts may be moistened so as to not cause dust and is better compacted once deposited. A spray from a water jet engaged to a reservoir of water is the current favored mode of depositing water. Additionally, preferred at the distal end of each of the three sections forming each conveyor, a hooded shroud is positioned to aid in directing the fill material downward to the next consecutive section of the conveyor.

As noted, each conveyor is telescopic in nature and has a plurality of translatable conveyor sections overlaying underlying conveyor sections. Each underlying conveyor is fed by the overlying conveyor and thus material is dispensed to the trench from the distal end of the lowest underlying conveyor segment. The conveyor segments of each telescopic conveyor are engaged to each other and to a means to change their elevation thereby providing inclining, level, and declining angles of discharge of the fill material exiting each individual conveyor.

By changing the position of one or both distal ends of both telescoping conveyers, the device operator is provided a means for extremely precise control of the position in which the fill material is placed. Narrowing the distance between both distal ends allows a means to position the two streams of earthen fill material closer to each other and conversely widening the distance will separate them more from each other. As noted earlier, the amount of material dispensed by each conveyor is variable by either or both adjusting the speed of one conveyor relative to the other, and adjusting the amount of material the slide gates acting as a regulator communicate to each respective conveyer.

Additional utility may be provided by a means for altering the center of gravity of the hopper and thereby the entire vehicle. This solves another vexing problem that exists with large machinery which in itself is heavy, and becomes even heavier when carrying fill material. Such machines conventionally are prone to tip over when the machine encounters a grade. The means for altering the center of gravity of the hopper allows the user, or a computer, to adjust the angle of the hopper from a normal position in relation to the frame of the machine to an ever increasing angle depending on the grade encountered and upon the weight of the fill placed in the hopper. Further, the conveyers can each be individually tilted relative to the ground and extended relative to the machine to provide a second and third means to balance the machine. In most cases the hopper and conveyors will level together on a grade to allow delivery of the material to the intended burial position. This maintains the belts substantially level such that fill material does not slide from the side edges of the elongated conveyers during use.

In this case, by using an axle at the base of the hopper and support frame for the conveyors and a hydraulic ram to tilt the hopper one direction or the other will provide an infinite number of different positions which may be established for the hopper and conveyors and a resulting number of adjustments of the center of gravity of the assembled machine to traverse the grade encountered.

An object of this invention is providing an easily used and maintained apparatus which provides for extremely accurate placement of fill material on construction sites, through the employment of two telescopic dispensing conveyors either on level ground or steep terrain.

It is a further object of this invention to provide such a placement of fill material in two individual streams each of which may be varied to each other, to thereby adjust the amount of fill deposited in each position on one or both sides of the pipe or structure to be buried, in infinitely variable respective quantities.

Yet another object of this invention is the provision of water injection by a water jet onto the fill material after leaving the hopper but before deposit on the ground, to minimize dust, help maintain the fill material on the conveyor belts, and aid in compaction.

An additional object of this invention is to provide a device allowing for use on steep grades without tipping over by the adjustment of the center of gravity of the load carried by the device during use in a plurality of manners of adjustment.

Yet another object of this invention is to minimize the waste and misplacement of fill material during backfill and burying of pipelines and underground utilities.

### BRIEF DESCRIPTION OF THE DRAWINGS

FIG. 1 is a side view of the device showing a hopper mounted on a powered vehicle with a plurality of telescopic conveyors extending to two different distal ends to dispense earthen material and the water injection system.

FIG. 2 depicts the hopper angled to achieve a balance for the vehicle and concurrently level telescopic belts extending from the hopper while on an inclined support surface.

FIG. 3 depicts a side view of the vehicle showing the two telescopic conveyors extending therefrom.

### DETAILED DESCRIPTION OF THE PREFERRED EMBODIMENTS OF THE INVENTION

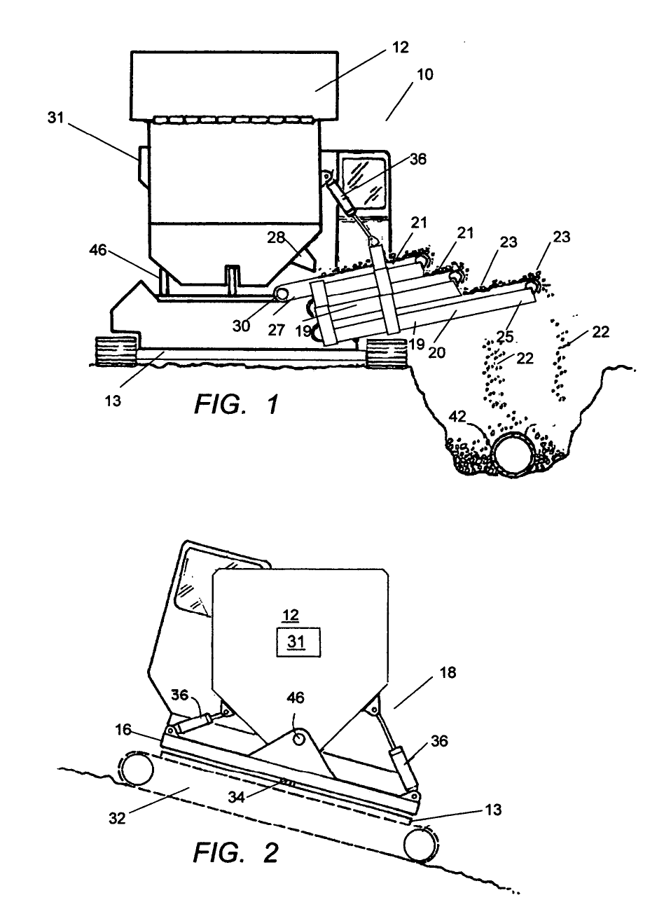

Referring now to the drawings in FIGS. 1-3, wherein similar parts are identified by like referenced numerals, and may appear in one or more of the figures, there can be seen in the various figures, depictions of favored modes of the device 10 herein. FIG. 1 depicts a side view of the device 10 as it would appear in operation as a complete unit with a hopper 12 providing a reservoir for fill material in two separate streams for a first telescopic conveyor 20 and second telescopic conveyor 25. While depicted as a completed self-propelled vehicle, it is anticipated that components of the device 10 may also be manufactured as attachments to conventionally used back filling devices and other motorized hopper type vehicles and such is anticipated.

In the current preferred mode of the device 10 all the various components are integrated to provide the complete device functioning in a symbiotic relationship to each other to achieve the desired results when burying structures in a trench. As shown, a hopper 12 which is filled by the user with one or combinations of conventional fill materials such as gravel, sand, soil, or similar conventionally used materials, is mounted upon an attachment point depicted in this case as the hopper axle 46 to the vehicle chassis 16 of a powered or self-propelled vehicle 18. The self-propelled vehicle 18 may be powered by conventional means for vehicle power such as gasoline or diesel engines which provide power via communicating hydraulic pumps or by drive shafts communicating the power to wheels or tracks or in other conventional means of powering a wheeled or treaded or similar such piece of construction equipment.

In the preferred mode of the device 10 a first conveyor means depicted by a first telescopic conveyor 20 is also mounted upon one of the chassis 16 or the hopper 12 so long as they are structurally adapted to support the load of the extended conveyor 20. A second conveyor 25 is also engaged in a similar fashion adjacent to the first conveyor 20. The conveyors 20 and 25 are shown, in the preferred mode, being telescopic which provides the most utility to the device as-earlier noted. A current especially preferred mode of the device 10 employs conveyors 20 and 25 having at least three overlying conveyor sections to allow for maximum collapsibility.

Both the first conveyor 20 and second conveyor 25 are independently adjustable for positioning the distal ends 23 of the conveyors 20 and 25 toward or away from the hopper 12 to thereby adjust the position of each of the two independent streams of discharged fill material 22 deposited by the respective distal ends 23. The material 22 stream for each conveyor 25 and 20, from the hopper 12 is independent of the other thereby maximizing the throughput of fill material 22 to each from the hopper 12 rather than dividing it.

Since the receiving point for the fill material 22 is generally in trenches, behind walls, over pipelines, on top of power lines, gas pipes, and other utility infrastructures which are buried, accurate placement is provided by the adjustability of each respective length of each respective conveyor 20 and 25 by translation of the individual conveyor sections making up the conveyor 20 or 25, relative to each other. With the two independent material streams feeding each conveyor which may be regulated, and the ability to slow or speed up the individual conveyors independently, the user is provided with infinite adjustability for the volume of flow of fill material 22 to the desired location from the distal ends 23 of the respective conveyors 20 and 25. Also, adjusting the distance between the two distal ends 23 thereby adjusts the exact positions where fill material 22 is deposited in the trench.

Both conveyers 20 and 25 function using conventional belts and transport fill material 22 communicated from the hopper 12, through the slide gates 28, at a respective receiving end 27, and convey that material 22 on a series of overlying rotating belts 21 to the distal end 23, for accurate placement in a desired location. The belts 21 are powered by a conventional means for powering the rotation of the belt 21 such as a hydraulically powered motor or an electric motor. In this embodiment, the conveyor 20 would have at least first and second conveyor belts 21 with the distal end 23 being laterally translatable in relation to the receiving end 27 which would receive material from the vehicle mounted and adjustable hopper. 12 thereby providing a means to telescope the conveyor sections of conveyers 20 and 25 over each other to form longer or shorter lengths to thereby independently position the distal ends 23 over the area to be filled.

Thus, the second conveyer belt 21, and third if three are employed as depicted, would receive fill material 22 from the overlying first conveyor belt 21 which is deposited there from the hopper 12 on the receiving end 27 of the uppermost section or segment 19 of the telegraphic conveyers. The second conveyor belt 21 and subsequent conveyor belts 21 of other translating segments 19 of each conveyor 20 and 25, would render the respective distal ends 23, user-positionable over the center or sides of the trench. This is easily accomplished by laterally translating the distal ends 23 of the final segment 19, to the appropriate position to deposit fill material 22 in the desired location.

This lateral translation of the second segment 19 and its conveyor belt 21 underneath an overlying subsequent conveyor segment 19, and translation of subsequent segments 19 each having conveyor belts 21, would be accomplished using hydraulic cylinders 36, mechanical gears, cables, or similar conventional means to translate the cooperatively engaged segments forming the conveyors 20 and 25 back and forth in relation to each other. On all of the conveyors 20 and 25, each conveyor segment 19 is individually translatable in a frame underneath any other conveyer segment 19 in-between it and the hopper 12. The result being that material deposited from the hopper 12 is always communicated to the uppermost belt 21 of the conveyer segment 19 closest to the hopper 12, and thereafter deposited to lower positioned sequential conveyor segments 19 on the way toward the distal end of the conveyor.

The ability to change the distance between the two distal ends 23 of the first and second conveyors 20 and 25, relative to each other, provides means to place two individualized flows of fill material 22, in two respective targeted positions, at two respective volumes, at a selected distance from each other. This works very well in cases of a pipe or cable being buried in a trench to provide extremely accurate placement of the material streams. This provides the ability to place fill material 22 simultaneously on both sides of the pipeline or other object being buried at independently variable rates.

Both telescoping conveyors 20 and 25, are selectively elevational by the user. Changes in elevation of both sectional telescoping conveyors 20 and 25, is provided in the preferred mode of the device using means for adjustment of the elevation of each conveyor 20 and 25, in the form of a rotational engagement 30 to the vehicle and a conventional hydraulic cylinder 36, or cable, or worm gear and sliding rear, or similar controllable means to adjust the angle of the conveyors 20 and 25 relative to their engagement to the vehicle 18. Adjusting the elevations of both conveyors 20 and 25, independently, thereby provides means to adjust the height of the distal ends 23 of the respective conveyers above the trench, and the force of the material 22 reaching the trench when discharged and falling from that end.

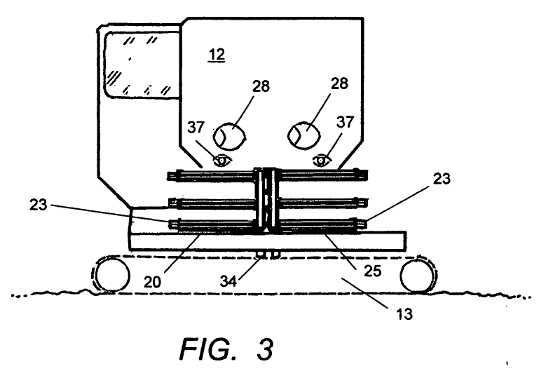

Means to regulate the volume of fill material dispensed independently from each of the conveyors is provided by fill material volume regulators in the form of slide gates 28 which can be adjusted to regulate the volume of fill material 22 communicated to each of the two conveyors 20 and 25. Thus, the exact volume of fill material 22 on each belt 21 of each conveyor 20 and 25 is independently adjustable in real time by the operator. The slide gates 28 can be a closeable aperture as shown in FIG. 3, or other conventional means to regulate the volume of material communicated out of the hopper 12 in real time. Hydraulic or electric controls would provide the operator with remote ability to change the volume of material 22 so dispensed while the belts 21 of each conveyor 20 and 25 are moving.

Each conveyor 20 and 25 independently thereafter communicates the regulated amount of earthen or fill material 22 communicated from the hopper 12 to its respective distal ends 23 thereby providing an extremely accurate means for placement of specific volumes of the material 22 in trenches, in two separate material streams, for placement behind walls, over pipelines, and in similar conventional positions in which fill material 22 is required.

Means to vary the volume of material 22 dispensed by each conveyor 20 and 25 is also provided by means to vary the speed of the belts 21 thereby giving the device 10 two means to vary the volume of material 22 dispensed from each distal end 23 of each conveyor. As noted the belts are powered in a conventional fashion using hydraulic or electrical power to the belt train. A valve will allow changes in hydraulic speed and a rheostat or analog control will allow for electrical motors to change speed and thus belt speed. The possible variance in respective speed between the two belts 21 of both conveyers 20 and 25 is essentially infinite since each can be adjusted to its own speed relative to the other at all times. By changing individual belt speeds, and depositing fill material 22 at a constant rate onto each belt of each conveyor 20 and 25, more material 22 will be deposited in the trench by the belt 21 which runs faster. This provides means to vary the volume of deposited material from each respective conveyor in each of two respective fill streams. This ability to deposit fill material precisely on target and in precise volume is especially important in the backfill operation involving pipelines and other trench buried infrastructures.

In the preferred mode of the device, the slide gates 28 are engaged between each conveyor and the flow of earthen material 22 from the hopper 12. Each slide gate 28 can regulate the volume of flow of material independently to its respective conveyor which constantly receives the fill material transported by the conveyor from the hopper 12 to the receiving end 27 of each conveyor for dispatch from its respective distal end 23. Thus, the belt speed adjustment provides a first means to regulate fill material 22 volume, and the opening and closing of the slide gates 28 regulating outflow of fill material to the conveyors provides a second means to regulate the volume of material 22 deposited in each material stream discharged from respective ends of the conveyors 20 and 25.

Finally, a third means to regulate fill material 22 volume to place more or less on one side of the pipe is provided by running conveyors 20 and 25 at different speeds, employing the slide gates 28 to dispense at different volumes, or a combination thereof.

In combination, belt speed and material volume regulation by each individual slide gate 29 would provide a third means for control of the volume of material 22 dispensed by each conveyor 20 and 25 independently. This is accomplished by both regulating the volume of fill material 22 deposited upon the receiving end 27 of each conveyor 20 and 25, and concurrently by varying the speed of each conveyor 20 and 25. Using one or a combination of conveyor speed and slide gate volume control the amount of fill material 22 placed in each separate material stream from each respective distal end of a conveyor is infinitely variable to the other.

The ability to adjust each telescopic conveyor 20 and 25 independently of the other allows the operator to deposit an exact volume of material 22 on each side of the pipe 42 to bury and protect it from direct contact with the falling material 22 if that is a concern. Individual adjustment of the length of the conveyors 20 and 25 to equal or differing distances from a center line, allows more or less fill material 22 to be deposited by one or the other of the conveyors on either side of a target. If more force is required by one stream of material 22 one of the conveyors 20 and 25 can be raised higher than the other and the increased force of material 22 falling a longer distance can be imparted.

As noted, also preferred in the device 10 is a means to tilt the-hopper 12 and the two telescopic conveyors 20 and 25, during transport and/or use to self correct its center of gravity and to level the hopper 12 and telescopic conveyors 20 and 25. This is provided by means to tilt the hopper 12 and frame engaged conveyors 20 and 25 which is shown as hydraulic cylinder 36. Additional means to adjust the center of gravity of the machine is provided by counter weights 31 positioned at the back of the hopper 12. This ability to adjust the counter weight 31 can be employed to counter act the force of the weight imparted to the vehicle 12 by the load of fill material 22 deposited in the hopper 12 and the extending conveyors 20 and 25, solves another vexing problem that exists with large machinery. Such machines, due to their mass and odd center of gravity caused by irregular shape and operational configurations, and the steep grades on construction sites, are prone to tip over. The means for altering the center of gravity of the hopper 12 allows the user, or a computer, to adjust the angle of the hopper 12 from normal to the vehicle 13 frame to a better angle, depending on the grade encountered and upon the weight of the fill 22 placed in the hopper 12.

As depicted in the figures a means for adjustment of the vehicle center of gravity is provided by the hopper 12 being attached to the vehicle chassis at an attachment point having a hopper axle 46 which rotationally attaches the hopper 12 to the chassis 16 of the powered vehicle 13. The axle 46 is situated adjacent to the base of the hopper 12 thus allowing the entire hopper 12 to rotate on the axle 46 at the connection point to the vehicle 13. The means to tilt the hopper 12 in this case is a hydraulic ram 36. However, other devices such as rack and pinion gearing, or electric solenoids could be used if desired or on vehicles so powered.

In an especially preferred-mode of the device 10 which aids in compaction and keeping the dust down from the fill material, a water jet 37 supplied by an onboard reservoir would be positioned over each belt to wet the fill material prior to dispensing into the fill positions.

Still further, in the preferred mode of the device 10 the chassis 16 is rotational upon a base frame 32 engaged to the wheels or tracks. This allows for rotation of the chassis and engaged hopper 12 and the conveyors 20 and 25 to positions more convenient during transport or use. For instance, the conveyors 20 and 25 may be collapsed and rotated to a position inline with the direction of travel of the vehicle 18 by rotation of the chassis 16 on the underlying frame 32 using means for rotational engagement such as a center bearing 34 using means to rotate one relative to the other such as a conventional user-controllable hydraulic or electric motor.

While all of the fundamental characteristics and features of the self propelled backfilling apparatus with controllable steering of fill material stream invention have been shown and described, it should be understood that various substitutions, modifications, and variations may be made by those skilled in the art without departing from the spirit or scope of the invention. Consequently, all such modifications and variations are included within the scope of the invention as defined by the following claims.

What is claimed is:

1. A vehicle for transport and placement of fill material, comprising:
a hopper, said hopper connected to-a central portion of a chassis of said vehicle at an attachment point, said central portion located between a front end and rear end of said chassis;
a first conveyor having a first moving surface, said first conveyor extending from a first end engaged to said chassis, toward a distal end;
a second conveyor having a second moving surface, said second conveyor extending from a first end engaged to said chassis, to a distal end;
a first discharge positioned to communicate a flow of said fill material in said hopper, onto-said first end of said first conveyor;
a second discharge positioned to communicate a flow of said fill material in said hopper, onto said first end of said second conveyor;
means for a tilting said hopper about said attachment point between a rearward angle substantially toward said rear end of said chassis and a forward angle substantially toward said front end of said chassis, said tilting thereby providing a means for adjusting the center of gravity of said vehicle;
one of said distal ends of said first and said second conveyor being positionable a distance from said chassis further than the other of said first and second conveyor; and
whereby said fill material deposited upon said first conveyor and said second conveyor, is depositable on or adjacent to a target position in two independent streams of said fill material, each of which communicates in a separate respective volume of said fill material from said hopper to said target position.

2. The vehicle of claim 1, additionally comprising:
means to control a speed of said first moving surface;
means to control a speed of said second moving surface;
each said volume of each of said two independent streams of said fill material being independently variable by changing the respective speed of either said first moving surface or said second moving surface.

3. The vehicle of claim 1, additionally comprising:
means to regulate said flow of said fill material from said first discharge onto said first conveyor;
means to regulate said flow of said fill material from said second discharge onto said second conveyor; and
each said volume of each of said two independent streams of said fill material being independently variable by a change in said flow of fill material from either said first or second discharge.

4. The vehicle of claim 2, additionally comprising:
means to regulate said flow of said fill material from said first discharge onto said first conveyor;
means to regulate said flow of said fill material from said second discharge onto said second conveyor; and
each said volume of each of said two independent streams of said fill material being independently variable by a change in said flow of fill material from either said first or second discharge.

5. The vehicle of claim 1, additionally comprising:
first means to deposit liquid upon said first moving surface;
second means to deposit liquid upon said second moving surface; and
whereby said fill material deposited on either said first or second moving surface may be moistened as a means to prevent dust.

6. The vehicle of claim 2, additionally comprising:
first means to deposit liquid upon said first moving surface;
second means to deposit liquid upon said second moving surface; and
whereby said fill material deposited on either said first or second moving surface may be moistened as a means to prevent dust.

7. The vehicle of claim 3, additionally comprising:
first means to deposit liquid upon said first moving surface;
second means to deposit liquid upon said second moving surface; and
whereby said fill material deposited on either said first or second moving surface may be moistened as a means to prevent dust.

8. The vehicle of claim 4, additionally comprising:
first means to deposit liquid upon said first moving surface;
second means to deposit liquid upon said second moving surface; and
whereby said fill material deposited on either said first or second moving surface may be moistened as a means to prevent dust.

9. The vehicle of claim 1, additionally comprising:
said vehicle having a base engaged to treads; and
said chassis rotationally engaged upon said base.

10. The vehicle of claim 2, additionally comprising:
said vehicle having a base engaged to treads; and
said chassis rotationally engaged upon said base.

11. The vehicle of claim 3, additionally comprising:
said vehicle having a base engaged to treads; and
said chassis rotationally engaged upon said base.

12. The vehicle of claim 5, additionally comprising:
said vehicle having a base engaged to treads; and
said chassis rotationally engaged upon said base.

13. The vehicle of claim 6, additionally comprising:
said vehicle having a base engaged to treads; and
said chassis rotationally engaged upon said base.

14. The vehicle of claim 1, additionally comprising:
said first conveyor formed of a plurality of overhanging telescopically engaged conveyor sections each having a said moving surface; and
said second conveyor formed of a plurality of overhanging telescopically engaged conveyor sections each having a said moving surface.

15. The vehicle of claim 2, additionally comprising:
said first conveyor formed of a plurality of overhanging telescopically engaged conveyor sections each having a said moving surface; and
said second conveyor formed of a plurality of overhanging telescopically engaged conveyor sections each having a said moving surface.

16. The vehicle of claim 3, additionally comprising:
said first conveyor formed of a plurality of overhanging telescopically engaged conveyor sections each having a said moving surface; and
said second conveyor formed of a plurality of overhanging telescopically engaged conveyor sections each having a said moving surface.

17. The vehicle of claim 4, additionally comprising:
said first conveyor formed of a plurality of overhanging telescopically engaged conveyor sections each having a said moving surface; and
said second conveyor formed of a plurality of overhanging telescopically engaged conveyor sections each having a said moving surface.

18. The vehicle of claim 7, additionally comprising:
said first conveyor formed of a plurality of sequentially overhanging telescopically engaged conveyor sections each having a said moving surface; and
said second conveyor formed of a plurality of sequentially overhanging telescopically engaged conveyor sections each having a said moving surface.

19. The vehicle of claim 9, additionally comprising:
said first conveyor formed of a plurality of sequentially overhanging telescopically engaged conveyor sections each having a said moving surface; and
said second conveyor formed of a plurality of overhanging telescopically engaged conveyor sections each having a said moving surface.

20. The vehicle of claim 10, additionally comprising:
said first conveyor formed of a plurality of sequentially overhanging telescopically engaged conveyor sections each having a said moving surface; and
said second conveyor formed of a plurality of overhanging telescopically engaged conveyor sections each having a said moving surface.
